(19) United States
(12) Patent Application Publication
(10) Pub. No.: US 2011/0211153 A1
(43) Pub. Date: Sep. 1, 2011

(54) LIGHTWEIGHT SUNGLASS LENSES FOR EYEGLASSES

(76) Inventor: Willie Willis, Lakeland, FL (US)

(21) Appl. No.: 12/843,214

(22) Filed: Jul. 26, 2010

Related U.S. Application Data
(60) Provisional application No. 61/237,123, filed on Aug. 26, 2009.

(51) Int. Cl. G02C 9/04; G02C 7/10

(52) U.S. Cl. 351/47

(57) ABSTRACT

A lightweight sunglass lens for eyeglasses system of the present invention is disclosed herein which may be removably attachable to the inside of a pair of eyeglasses to provide protection to a user's eyes from harmful ultraviolet rays emitted by the sun while further protecting the user's periphery vision as a result of the curved sun blocking lens. The lightweight sunglass lens for eyeglasses system may be manufactured from a lightweight, durable plastic material providing comfort to the user and may be removably attachable to the arms of an existing pair of eyeglasses using non-front-mount clip-attachers integrated into the lightweight sunglass lens for eyeglasses system. Further, lightweight sunglass lens for eyeglasses system may comprise a kit for use.

### CROSS-REFERENCE TO RELATED APPLICATION

The present application is related to and claims priority from prior provisional application Ser. No. 61/237,123, filed Aug. 26, 2009 which application is incorporated herein by reference.

### BACKGROUND OF THE INVENTION

1. Field of the Invention

The present invention relates generally to the field of sunglass lenses and more specifically relates to a method and apparatus for removably attaching a sunglass lens to eyeglasses.

2. Description of the Related Art

Prescriptive eyeglasses may be worn to improve a wearer's eyesight while sun glasses may be worn to protect the wearer's eyes from harmful ultraviolet rays emitted by the sun. Eyeglasses may also be worn to shield the wearer against wind, rain, and other elements. Furthermore, eyeglasses may be worn as a fashion trend or to convey an intellectual image.

For those who have poor vision and wear traditional eyeglasses, it is not uncommon to purchase prescription sunglasses that may be worn during the daylight. However, prescription sunglasses are often very expensive to purchase. Furthermore, the vision of individuals who wear eyeglasses will typically deteriorate over time and it may become an expensive cycle to purchase a new pair of prescriptive sunglasses every few years or more. As a result, many such individuals may use standard front-mount clip-on attachments to provide a sunglass enhancement to their existing eyeglasses.

In today's sunglass lens market, many clip-on lens attachments are designed to be affixed directly in front of the eyeglass lens (front-mount) and therefore do not adequately block the sun from one's peripheral vision. This may cause the user to painfully squint while outside which may hinder their vision and lead to frustration. Thus, a need exists for having a simple means to attach sunglass lenses to a pair of eyeglasses so the sunglass lenses are both light in weight and comfortable to the wearer while completely shielding the peripheral vision from the sun.

Various attempts have been made to solve the above-mentioned problems such as those found in U.S. Pat. Nos. 6,386,703, 6,799,846, 5,412,438, 5,790,230, 6,773,105, and 5,696,571. This prior art is representative of attachable sunglasses to eyeglasses. None of the above inventions and patents, taken either singly or in combination, is seen to describe the invention as claimed.

Ideally, a lightweight sunglasses for eyeglasses should operate safely and be manufactured at a modest expense. Thus, a need exists for lightweight sunglass lens for eyeglasses system to provide a prescriptive eyeglass wearer an effective and economical means for removably attaching a sunglass lens to the wearer's eyeglasses that are easy to attach and detach, light in weight, and that fully protect the wearer's periphery from the sun.

### BRIEF SUMMARY OF THE INVENTION

In view of the foregoing disadvantages inherent in the known sunglasses art, the present invention provides a novel sunglass lens system. The general purpose of the present invention, which will be described subsequently in greater detail, is to provide a novel method and apparatus for attaching sunglass lens to an existing pair of eyeglasses.

A lightweight sunglass lens system is described herein for use with an existing pair of eyeglasses comprising a curved sun blocking lens and at least one (preferably two) clip-attacher(s) having friction attaching means wherein the curved sun blocking lens may be removably couplable to an inner surface of the pair of eyeglasses via side clip-attachers and rest on the nose pad arms.

In the preferred embodiment, the lightweight sunglass lens system comprises a curved sun blocking lens so as to more completely shield a user's eyes from harmful ultraviolet (UV) rays emitted by the sun. The user's periphery vision may be shielded by the curved sun blocking lens as a result of the inwardly concave characteristic of the sun shielding lens. Furthermore, the lightweight sunglass lenses system may be manufactured using lightweight, durable plastic and the curved sun blocking lens may comprise a nose area in the center which may further be manufactured in a variety of sizes to fit different size nose openings in eyeglasses.

The present invention holds significant improvements and serves as a sunglass lens system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Lightweight Sunglass Lens for use with Existing Eyeglasses, constructed and operative according to the teachings of the present invention.

FIG. 1 is a perspective view illustrating a lightweight sunglass lens system in an “in-use” condition according to one embodiment of the present invention.

FIG. 2 is a perspective view illustrating the lightweight sunglass lens system comprising a curved sun blocking lens that may be removably attachable to a pair of eyeglasses according to one embodiment of the present invention.

FIG. 3 is a perspective view which illustrates the curved sun blocking lens according to one embodiment of the present invention.

FIG. 4 illustrates a method of use of the lightweight sunglass lens system.

### DETAILED DESCRIPTION

As discussed above, embodiments of the present invention relate to a lightweight sunglass lens for eyeglasses system 100 and more particularly to a lightweight sunglass lens for eyeglasses system 100 that may be removably attachable to an existing pair of eyeglasses 120 to provide user 140 with a protective means for blocking harmful ultraviolet rays emitted by the sun. Generally, lightweight sunglass lens for eyeglasses system 100 is worn by user 140 being located on user's nose 148 with user 140 wearing existing eyeglasses 120, wherein lightweight sunglass lens for eyeglasses system 100 provides side shielding protection from sun rays.

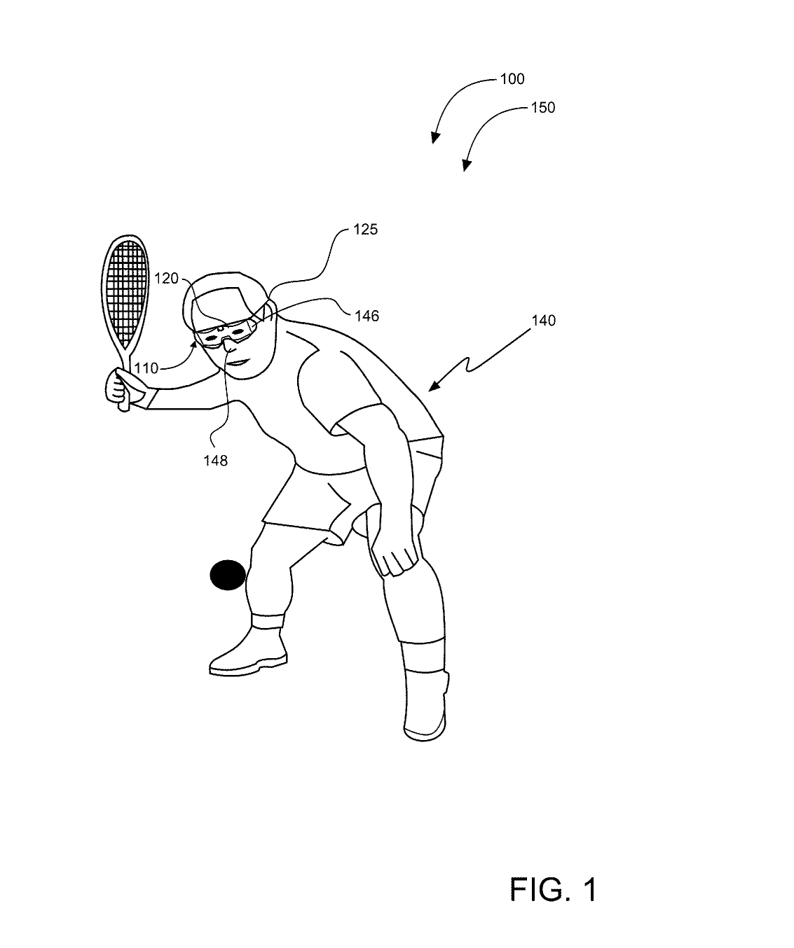

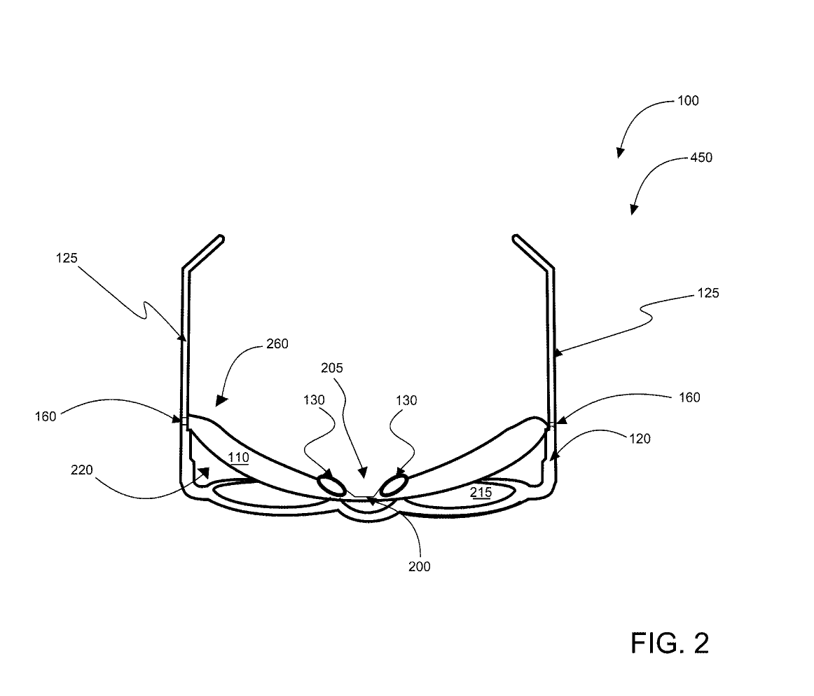

Referring now to FIGS. 1 and 2, illustrating perspective views of lightweight sunglass lens for eyeglasses system 100, showing curved sun blocking lens 110 which may be substantially contained within inner perimeter 260 of pair of eyeglasses 120, as shown. Periphery region 220 may be shielded from the rays of the sun via curved sun blocking lens 110. Periphery region 220 comprises the space between eyeglass lenses 215 and eyes 146 of user 140 as shown in FIG. 1. User 140 may benefit from the concave nature of curved sun blocking lens 110 due to user 140 no longer being required to squint his or her eyes 146 when peering out of periphery region 220 because of the increased shielding effect provided. Curved sun blocking lens 110 may be removably attachable to a pair of eyeglasses 120 via at least one, preferably two side clip-attachers 160 and rest in stasis on arms of nose pads 130.

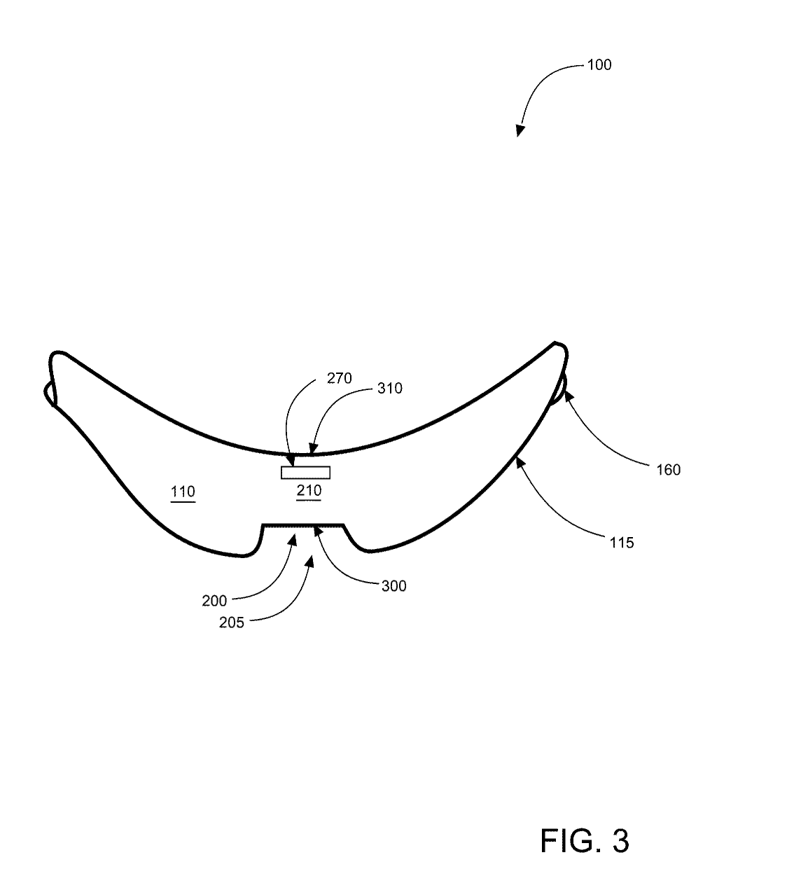

According to one embodiment of the present invention as shown in FIG. 3, lightweight sunglass lens for eyeglasses system 100 may comprise at least two side clip-attachers 160 located along lens periphery 115 of curved sun blocking lens 110. As best seen in FIG. 2, side clip-attachers 160 may snappably fasten to eyeglasses arms 125 of pair of eyeglasses 120. In other embodiments of lightweight sunglass lens for eyeglasses system 100, side clip-attachers 160 may utilize hook and-loop fastening means for securing curved sun blocking lens 110 to pair of eyeglasses 120. Other suitable mount-fastening means may also be used. In the various embodiments as shown in FIG. 1, user 140 may easily attach and detach curved sun blocking lens 110 to pair of eyeglasses 120 when moving between indoor and outdoor environments. During non-use storage periods of lightweight sunglass lens for eyeglasses system 100, curved sun blocking lens 110 may be attached using an external off-the-shelf clip (alligator clip, clothes clip or other) using rectangular hole 270 to a suitable surface.

As discussed above, embodiments of the present invention relate to a lightweight sunglass lens for eyeglasses system 100 and more particularly to a lightweight sunglass lens for eyeglasses system 100 that may be removably attachable to an existing pair of eyeglasses 120 to provide user 140 with a protective means for blocking harmful ultraviolet rays emitted by the sun.

Referring again now to FIG. 1, illustrating lightweight sunglass lens for eyeglasses system 100 in an ‘in-use’ condition 150 attached to pair of eyeglasses 120 as worn by user 140. Lightweight sunglass lens for eyeglasses system 100 generally comprises curved sun blocking lens 110 preferably with at least two side clip-attachers 160 located along lens periphery 115 of curved sun blocking lens 110. Curved sun blocking lens 110 may be removably attachable to eyeglasses arms 125 of eyeglasses 120 via side clip-attachers 160 (or other suitable means in alternate embodiments) as best shown in FIGS. 2 and 3. Curved sun blocking lens 110 may preferably follow a brow line profile of user 140 thereby providing substantially complete shielding protection from the ultraviolet rays emitted by the sun. Furthermore, curved sun blocking lens 110 may be interlockable with eyeglasses nose pads 130 thereby preferably providing a more secure fitting of curved sun blocking lens 110 to eyeglasses 120. While in an “in-use” condition, lightweight sunglass lens for eyeglasses system 100 may have limited displacement as a result of the combination of side clip-attachers 160 working in conjunction with the interlocking of eyeglass nose pads 130 (and/or nose pad arms) with curved sun blocking lens 110. These and other features are very useful when performing work and/or sporting activities when using the present invention.

Referring now to FIG. 3, illustrating a perspective view of lightweight sunglass lens for eyeglasses system 100, curved sun blocking lens 110 may further comprise nose area 200 located along bottom perimeter 300 in center 310 of curved sun blocking lens 110. Nose area 200 comprises open space 205 whereby user 140 may rest lightweight sunglass lens for eyeglasses system 100 on nose 148 of user 140. Further, lightweight sunglass lens for eyeglasses system 100 in certain embodiments may not rest on nose 148 of user 140. Curved sun blocking lens 110 of the present invention may be manufactured using lightweight, durable plastic material, preferably providing a comfortable sun shielding accessory for pair of eyeglasses 120.

Lightweight sunglass lens for eyeglasses system 100 comprises kit 450 comprising curved sun blocking lens 110 and clip-attachers 160 having friction attaching means and optionally a set of user instructions. Kit 450 may also comprise replacement clip-attachers. Kit 450 may also comprise additional storage clips such for suitable attachment to surfaces such as the individuals clothing, sunvisors, pockets, hats, or other suitable surfaces.

Upon reading this specification, it should be appreciated that, under appropriate circumstances, considering such issues as user preferences, design preference, structural requirements, marketing preferences, cost, available materials, technological advances, etc., curved sun blocking lens 110 of lightweight sunglass lens for use with an existing eyeglasses system 100 may be manufactured in a variety of styles, colors, and tint levels to appeal to a wide market of sunglass users 140. Furthermore, open space 205 of nose area 200 may also be manufactured to allot for more or less space to comfortably fit a variety of nose 148 sizes.

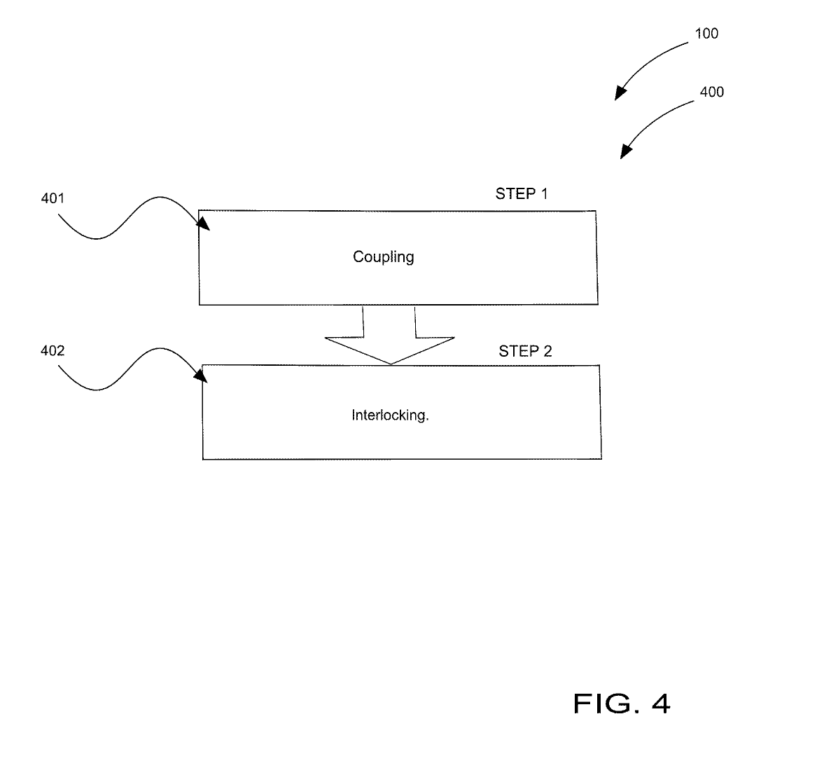

Referring to FIG. 4 illustrating a preferred method of use 400 of lightweight sunglass lens for eyeglasses system 100 comprising: step one 401 installing curved sun blocking lens 110 on an inner surface of pair of eyeglasses 120 using integrated side clip-attachers 160 to eyeglass arms 125 of pair of eyeglasses 120; and step two 402 simultaneously interlocking nose area 200 of curved sun blocking lens 110 to arms of eyeglasses nose pads 130 of pair of eyeglasses 120 in order for curved sun blocking lens 110 to be held in stasis by at least three (preferably four) connecting points; optionally step three may include removing curved sun blocking lens 110 from eyeglasses 120 and using rectangular hole 270 for storing lightweight sunglass lenses for eyeglasses system 100 using at least one type of external off-the-shelf clip (alligator clip, clothes clip or other).

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A lightweight sunglass lens for use with an existing eyeglasses system comprising:
at least one curved sun blocking lens; and
at least one clip-attacher having friction attaching means;
wherein said curved sun blocking lens is removably attachable to an inner surface of a pair of eyeglasses via said clip-attacher(s) and rest on nose pad arms of said eyeglasses.

2. The lightweight sunglass lens of claim 1 wherein said clip-attacher removably couples said curved sun blocking lens to an arm portion of said pair of eyeglasses.

3. The lightweight sunglass lens of claim 1 wherein said curved sun blocking lens is contained within an inner perimeter of said pair of eyeglasses thereby more completely shielding the periphery region of a user's vision from side-glare.

4. The lightweight sunglass lens of claim 1 wherein said lightweight sunglasses comprises a lightweight, durable tinted plastic material.

5. The lightweight sunglass lens of claim 1, wherein said attachment means for said lightweight sunglasses includes at least two clips for snap-locating and attaching said curved sun blocking lens to said arms of said pair of eyeglasses.

6. The lightweight sunglass lens of claim 1, wherein a nose area of said curved sun blocking lens has a cut-out section to fit around a user's nose.

7. The lightweight sunglass lens of claim 6, wherein said nose area of said curved sun blocking lens is interlockable between nose-pads and a frame of said pair of eyeglasses.

8. The lightweight sunglass lens of claim 1, wherein said attachment means for said lightweight sunglasses includes at least two hooks for non-snap-locating and attaching said curved sun blocking lens to said arms of said pair of eyeglasses.

9. The lightweight sunglass lens of claim 1, wherein said curved sun blocking lens follows a brow line profile of said user.

10. The lightweight sunglass lens of claim 1, further comprising a rectangular hole usable for storage using at least one type of external off-the-shelf clothes clip.

11. A lightweight sunglass lens made of a lightweight, durable tinted plastic material for use with an existing eyeglasses system comprising:
at least one curved sun blocking lens wherein said curved sun blocking lens is contained within an inner perimeter of said pair of eyeglasses thereby shielding the periphery region of a user's vision from side-glare; and
at least one side clip-attacher having friction attaching means wherein said clip attacher removably couples said curved sun blocking lens to an arm portion of said pair of eyeglasses; and
wherein said curved sun blocking lens is removably couplable to an inner surface of said pair of eyeglasses via said side clip-attacher(s).

12. The lightweight sunglass lens of claim 11 wherein said lightweight sunglass lens for existing eyeglasses system comprises a kit including:
at least one said curved sun blocking lens; and
said side clip-attacher(s) having friction attaching means;
at least one said off-the-shelf clip suitably fit to a rectangular hole in said sun blocking lens; and
a set of user instructions.

13. A method of using a lightweight sunglass lens for eyeglasses system comprising the steps of:
removably coupling a curved sun blocking lens to an inner surface of a pair of eyeglasses using integrated clip-attachers to arms of said pair of eyeglasses; and
simultaneously interlocking a nose area of said curved sun blocking lens to nose pad arms of said pair of eyeglasses such that the curved sun blocking lens is held in stasis by at least three connecting points.

14. The method of claim 13 further comprising the step of:
removing said curved sun blocking lens from said eyeglasses; and
using a rectangular hole for storage of said lightweight sunglass lens for eyeglasses system using at least one type of external off-the-shelf clip.
